(19) United States
(12) Patent Application Publication
(10) Pub. No.: US 2006/0013095 A1
(43) Pub. Date: Jan. 19, 2006

(54) Method and apparatus for detecting defects on optical disk

(75) Inventors: Tun-Hsing Liu, Ping Jen City (TW); Chun-Ying Chiang, Chia I City (TW); Hong-Ching Chen, Feng Shan City (TW)

Correspondence Address: BIRCH STEWART KOLASCH & BIRCH, PO BOX 747, FALLS CHURCH, VA, 22040-0747, US

(73) Assignee: MEDIATEK INCORPORATION

(21) Appl. No.: 11/183,936

(22) Filed: Jul. 19, 2005

(30) Foreign Application Priority Data
Jul. 19, 2004 (TW) 93121490

(51) Int. Cl. G11B 7/00

(52) U.S. Cl. 369/53.15; 369/47.14; 369/44.32

(57) ABSTRACT

A defect detecting apparatus and a defect detecting method performs highly efficient and reliable defect detection over an optical disk. According to the defect detecting method, defect information is obtained during data recording. The necessity of data verification and the range of verification-demanding area are determined according to the defect information. The defect address is found efficiently by performing a data verification procedure over the verification-demanding area. The defect detecting method according to the present invention conducts data verification on defect-prone addresses instead performing a global examination for address areas recorded with data. Thereby, the defect detecting efficiency is enhanced.

### BACKGROUND OF THE INVENTION

1. Field of the Invention

The present invention relates to a defect detecting apparatus and method for the same, and especially to a defect detecting apparatus using a conditional verification mechanism to enhance detection efficiency and a method for the same.

2. Description of Related Art

Conventional recordable and rewritable optical disks, such as CD-R/RW, DVD+R/RW, DVD−R/RW, and DVD RAM, are generally formed with a plurality of pre-grooves having predetermined wobbling frequencies. The wobbling frequencies of the pre-grooves formed on the optical disk are used to identify physical information related to the disk, such as, for example, ATIP format for CD-R/RW, ADIP format for DVD+R/RW, Pre-pit format for DVD−R/RW, and CAPA format for DVD RAM. When accessing an optical disk, an optical disk drive reads the physical information pertaining to the pre-grooves for controlling the optical pickup head, determining the accessing address for reading/writing operation and facilitating the production of servo signals. The pre-grooves of an optical disk and related information are well defined in the official specification of optical disk; therefore, the details thereof are not given here.

Conventional rewritable optical disks suffer from certain defects during manufacture and even usage thereof. The defects can be caused by a scratch on the disk, non-uniform dye and/or dye deterioration. The optical disk drive needs to detect defects on an optical disk and take suitable measures to ensure data integrity. Therefore, several methods, such as CD Mt. Rainier, DVD Mt. Rainier, and DVD-RAM, are suggested for defect management. In the above methods, the optical disk drive first performs defect detection over the optical disk and obtains defect information. Once a defect is found, defect management is performed. For example, if a defect is found in an optical disk's data area, the user's data originally needed to be recorded on a position with the defect are recorded on a mapping position in a spare area of the optical disk, and both the defect and the mapping positions are also recorded on the optical disk.

In general, the optical disk drive performs defect detection under the following two situations:

1. The optical disk drive intends to verify the recording quality and reproduction integrity when there is user's data that needs to be recorded on a designated position of an optical disk. During the recording process, the optical disk drive first records the user's data and defect detection on the designated position to check whether the designated position has a defect. After that, the optical disk drive performs the defect management operation if a defect is found.

2. The optical disk drive performs a formatting process on a designated area of the optical disk in order to ensure recording quality and reproduction integrity of this area. In the formatting process, the optical disk drive writes specific data onto the designated area and performs defect detection over the designated area. Moreover, if a defect is found, any necessary defect management related thereto is performed.

In the two situations mentioned above, the optical disk drive has different operative steps, records different types of data, and performs different kinds of defect management. However, the optical disk drive has the same data-recording action and defect detection action in these two situations.

In general, conventional optical disk drives evaluate data-recording quality by reading the data recorded on an optical disk. For example, conventional optical disk drives can check the data error rates determined in the data-reading process or the decoding results of the data read from the optical disk to evaluate the data-recording quality.

Taking a DVD disk as an example, the smallest logical data unit on a DVD is referred to as a sector, which includes 4-byte identification data (ID), 2-byte ID error detection (IED) data, 6-byte copyright management information (CPR_MAI), 2048-byte main data and a 4-byte error detection code (EDC). Every 16 sectors form an ECC block. In the RSPC error correction encoding process, each ECC block is attached with 16 rows of PO codes (parity of outer code) and 10 columns of PI codes (parity of inner code). The PO codes and PI codes are used for correcting the data read from an optical disk.

When the error rate determined in the decoding process of the PI codes associated with a data address exceeds a threshold value, the data recorded in this data address is not reliable and the data address is marked as defective. Moreover, when an error is found in the decoding process of the EDC, the data stored in a data address related thereto is erroneous and the data address is marked as defective. Moreover, a defect can also found by checking the correctness of the identification data (ID).

Similarly, for finding defects on a CD, the optical drive can check the error rates of C1 and C2 codes or the decoding results of EDC.

FIG. 1 shows a schematic view of a defect-detecting apparatus in a related art for an optical disk. The defect-detecting apparatus comprises a PUH 101, a writing means 103, a reading means 105, a controller 107, a defect detector 109 and a defect manager 111. For writing data on an optical disk, the controller 107 sends the data to be written to the writing means 103 and then the writing means 103 sends the data to the PUH 101 for writing the data onto the optical disk by a laser beam of the PUH 101.

After a predetermined amount of data is recorded, the PUH 101 and the reading means 105 are driven by the controller 107 for reading the recorded data and checking the recording quality. The defect detector 109 senses the presence of a defect by evaluating the recording quality, such as the error rate of the accessed data and the decoding result of the accessed data.

The defect manager 111 writes the data, which is to be written to a position with a defect in the data area, to a mapping position of the spare area through the controller 107 once the defect is found. The defect position and mapping position are also recorded. In this way, the data can be correctly recorded and reproduced.

FIG. 2 is a schematic view showing the defect detection procedure in a related art. For recording data, the PUH 101 seeks the track of the disk 120 corresponding to the address to be recorded with the data, and then the PUH 101 writes the data to the address. As shown in this figure, the elapsed time for the track-seeking operation and the data-writing operation is (To+Tw).

The PUH 101 jumps back to the initial location for reading and verifying the recorded data after recording a predetermined amount of data. Moreover, defect detection and defect management are also performed on the read data; the position with the defect is marked with an “x” in this figure. The elapsed time for PUH jumping back and data verification are Tj and Tr respectively.

When the amount of data to be recorded is larger than the buffer capacity of the optical disk drive, the data is divided into a plurality of data sections. The recording of each data section repeats the steps shown in FIG. 2. Thus, the minimal time cost for recording each data section is (To+Tw)+Tj+Tr

As can be seen from the above description, the optical disk drive in the related art will move back the PUH for verifying recorded data, regardless of whether a defect is present or not. The time cost for writing the data section is at least (To+Tw)+Tj+Tr.

Moreover, the optical disk drive will divide the recorded data into multiple data sections and recode each data section in an intermittent manner when the amount of data to be recorded is larger than the buffer capacity of the optical disk drive. The recording operation for each data section involves the PUH jumping back. The total elapsed time for recording and verifying data in an intermittent manner is inevitably larger than that for recording and verifying data in a sequential manner.

On the other hand, the allowable defect rates for the defect management standards of rewritable optical disks are minute ones. The allowable defect rate for CD Mt. Rainier is 5.88%. The allowable defect rate for DVD Mt. Rainier normal is 3%. The allowable defect rate for DVD Mt. Rainier extensive is 13%. The optical disk is determined to be abnormal when the error rate thereof exceeds the allowable value.

The defect detecting apparatus in the related art suffers from inefficiency because the defect detection needs to be performed even on defect-free areas of the optical disk, and the defect-free areas are predominant on a normal optical disk.

### SUMMARY OF THE INVENTION

It is the object of the present invention to provide a defect detecting apparatus using conditional verification mechanisms to enhance detection efficiency and a method for the same.

In one aspect of the invention, the defect detecting apparatus uses a reliability detector to generate a detection result with defect-prone addresses. The verification-demanding area and verification-demanding temporal range are determined according to the detection result.

In another aspect of the invention, the verification-demanding area and verification-demanding temporal range are determined according to the preexistent states/information of an optical disk before recording, and/or the dynamic disk states/information during data recording.

In view of the above objects and aspects, the present invention provides a defect detecting method. According to the defect detecting method, defect information is discovered during data recording. The necessity of data verification and the range of verification-demanding areas are determined according to the defect information. A defect address is found efficiently by performing a data verification procedure over the verification-demanding areas.

In view of the above objects and aspects, the present invention provides a defect detecting apparatus, which comprises a verification determinator determining the necessity of having to perform a data verification procedure on a verification-demanding area according to defect information; a controller performing the data verification procedure over a verification-demanding area determined by the verification determinator; a reading means controlled by the controller for reading recorded data on the optical disk; and a defect detector finding a defect address of the optical disk by the data verification procedure and the read data.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWING:

The features of the invention believed to be novel are set forth with particularity in the appended claims. The invention itself however may be best understood by reference to the following detailed description of the invention, which describes certain exemplary embodiments of the invention, taken in conjunction with the accompanying drawings, in which:

FIG. 1 shows a schematic view of a defect-detecting apparatus for an optical disk in a related art;

FIG. 2 is a schematic view showing a defect detection procedure in a related art;

FIG. 3 shows the block diagram of the defect detecting apparatus for an optical disk according to the present invention;

FIG. 4 shows a flowchart of a defect detecting method according to the first preferred embodiment of the present invention; and

FIG. 5 shows a flowchart of a defect detecting method according to the second preferred embodiment of the present invention.

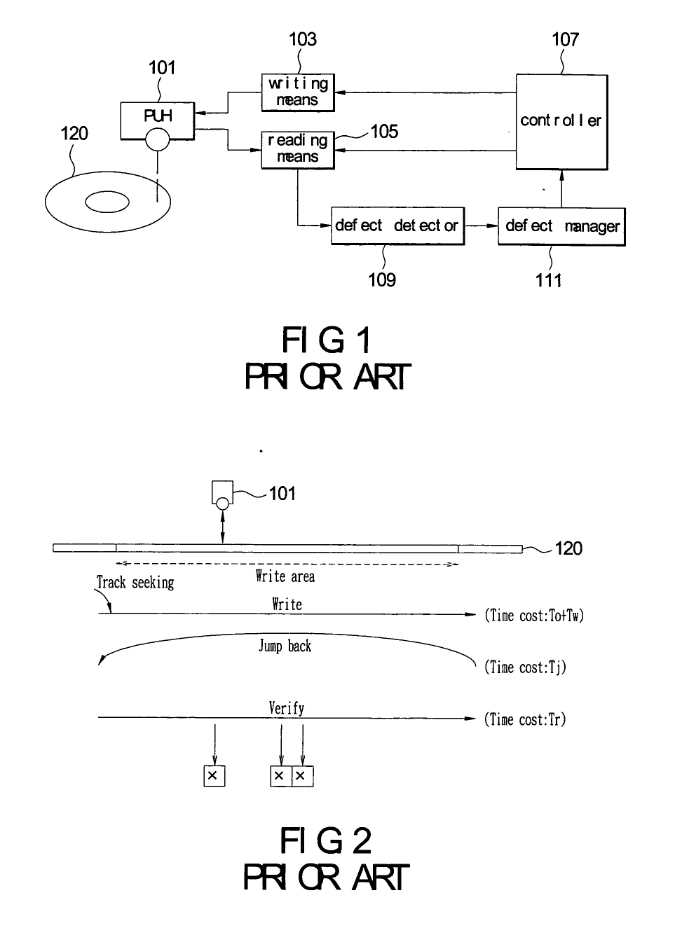

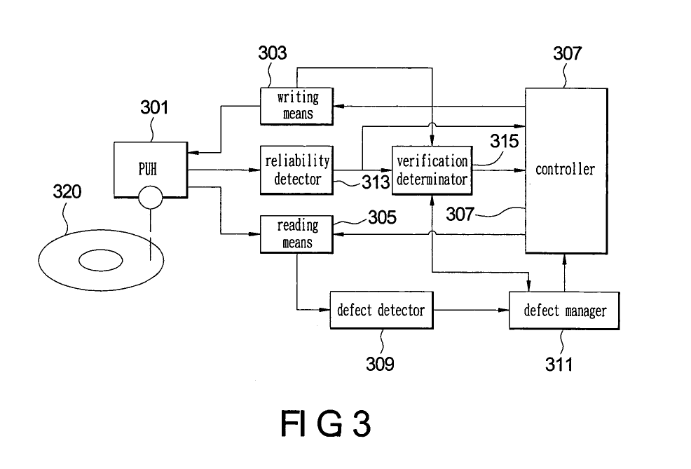

### DETAILED DESCRIPTION OF PREFERRED EMBODIMENTS

FIG. 3 shows a block diagram of the defect detecting apparatus for an optical disk according to the present invention. The defect detecting apparatus comprises a PUH 301, a writing means 303, a reading means 305, a controller 307, a defect detector 309, a defect manager 311, a reliability detector 313 and a verification determinator 315.

For writing data onto an optical disk, the controller 307 sends the data to be written to the writing means 303 and then the writing means 303 sends the data to the PUH 301 for writing data onto the optical disk 320 by a laser beam thereof. Moreover, the reliability detector 313 in the defect detecting apparatus also detects any abnormal signals in the written data and sends the detected defect-prone information to the verification determinator 315.

The reliability detector 313 performs a reliability detecting process on the optical disk when recording the user's data. This means that the reliability detector 313 detects any abnormal signals which cause defects possibly in the written data with reference to, but not limited to, the following signal and information including a reflection signal of the optical disk, a PUH control signal, a servo signal, a servo state, a wobble signal, and physical information of the pre-grooves. The optical disk may have a reliability issue when the reliability detector 313 detects an abnormal signal or abnormal information. The abnormal signal and abnormal information may be caused by various factors like a defect of the disk per se, non-ideal pre grooves, or a mismatch between a dye and a recording power and a drive vibration. The recording quality or the reliability of the recorded signal is questionable if any one of the above abnormal signals or abnormal information is detected.

The optical signals detected by the sensors of PUH can be classified into two groups: a main beam and a side beam. The main beam includes A, B, C, and D beams and is a central portion of the reflected optical signal. The side beam includes E, F (or G, H) beams and is a peripheral portion of the reflected optical signal. An SBAD (sub-beam add) signal is the sum signal of E, F, G, and H beams and is used to detect scratches or dirt on the disk. Moreover, scratches or dirt on a disk can also be manifested by the magnitude variation of a RF signal from the optical disk. The reliability of the recorded data is influenced by scratches or dirt on the disk. Therefore, the reliability detector 313 can evaluate the reliability of the recorded data by using at least one of, or both of, the above two methods.

The reliability of the recorded data can be evaluated in other ways as well. For example, the wobbling signal containing physical information of the optical disk should have a stable range upon detection. The reliability of the recorded data is uncertain when the wobbling signal is unstable. Moreover, the physical information, such as the ID code, the address code and a synchronous pattern, prerecorded on the optical disk, has predetermined values upon detection and decoding. The reliability of the recorded data is uncertain when the physical information is abnormal. Therefore, the reliability detector 313 can further evaluate the reliability of the recorded data by using at least one of, or both of, the above two approaches. The wobbling signal and physical information of the optical disk are well known art and are not explained in detail here.

Moreover, the PUH should be servo-controlled to follow stably the track of the optical disk during recording or reproducing. The detection signal of PUH, such as a tracking error (TE), a focusing error (FE), a track deviation signal and a run-out signal, should have a stable range. The reliability of the recorded data is uncertain when the detection signal of the PUH is abnormal. Therefore, the reliability detector 313 can further evaluate the reliability of the recorded data by the detection signal of the PUH.

Moreover, the servo-control signal for the PUH should be stable during recording. Once a servo-control signal error, such as a steady state error, a phase shift error, an unstable frequency error or an unlock error, is found, the recording quality is prone to uncertainty. Therefore, the reliability detector 313 can further evaluate the reliability of the recorded data by the servo-control signal for the PUH.

Moreover, the optical disk drive also performs an optical power calibration (OPC) during recording. The OPC result can be used to find mismatched recording power, abnormal optical disk and disk defects. Therefore, the reliability detector 313 can further evaluate the reliability of the recorded data by the OPC result.

As can be seen from the above description, the reliability detector 313 discovers defects on the optical disk when it receives an abnormal signal, when it detects any abnormal state, or a combination thereof. The situations stated above are used for demonstration purposes only and are not limiting of the present invention.

The verification determinator 315 will decide the necessity of data verification and verification-demanding areas after receiving the detection results from the reliability detector 313. Upon affirming the necessity of data verification, the verification determinator 315 commands the controller 307 to drive the reading means 305 and the PUH 301 for reading the data in the defect-prone address area. The defect detector 309 identifies the presence of an actual defect and a physical address of the defect by examining the data integrity such as an error rate of read data, decoding integrity or essential information integrity.

In the case of DVD disks, such as DVD Mt. Rainier disks or DVD-RAM disks, the actual defect can be identified through error rate (PI, PO error rate) or EDC. Any defect-prone addresses can be judged as being defective when the error rate of PI code of data in that address exceeds a predetermined threshold. Alternatively, the defect-prone address can be judged as a defect address when the EDC of data in that address manifests occurrences of error. Alternatively, the defect-prone address can be judged as a defect address when the essential information, such as sector ID and synchronous pattern, of data in that address manifests occurrences of error.

In case of CD disks, such as CD Mt. Rainier disks, the actual defect can be identified by an error rate (C1, C2 error rate) or an EDC. Moreover, any defect-prone addresses can be judged as being defective when the essential information, such as a header and a synchronous pattern, of data in that address manifests occurrences of error.

The above approaches for discriminating actual defects have different criteria for disks of different formats. In the approaches of the present invention, the quality of read data is evaluated to discriminate actual defects and the addresses thereof. More particularly, the read data that is discriminated to have actual defects if an imperfection or uncertainty (being not reliable) is found in the data. In the present invention, the defect detector 309 identifies the presence of actual defects in view of data quality; the discrimination criteria can vary for different kinds of optical disks and can be based on any information contained in the read data or obtained during the accessing operation.

If an actual defect is present, the defect manager 311 will command the controller 307 to allocate the data to be written to a defect address to a spare area and record the defect information such as a defect address and the mapping information for the defect address. If the actual defect is found in a formatting procedure, the defect information is recorded and the allocation of data is not performed.

It should be noted that the reliability detector 313 performs an initial identification for the questionable data and the associated defect-prone address in the present invention. The reliability detector 313 is less precise in comparison with the defect detector 309. The reliability detector 313 locates the range of the defect-prone address and the actual defect address is found by performing more precise verification mechanisms over the defect-prone address.

The verification determinator 315 determines the necessity of data verification and the address areas that require verification based upon the disk's state/information and the results received from the reliability detector 313. For example, the verification determinator 315 can refer to preexistent states/information before data recording to determine the necessity of data verification. The preexistent states/information includes a number of overwriting times on an optical disk, frequently overwritten areas, important data areas, outer areas of optical disk, inferior areas identified by optical disk parameters, inferior areas identified by an OPC result, and inferior areas identified by defect records. Moreover, the verification determinator 315 can refer to dynamic disk states/information refreshed during data recording to determine the necessity of data verification and verification-demanding area. The dynamic disk states/information during data recording includes a recording address, a recording area, an overwriting number, a defect distribution, and an accumulated defect signal.

More particularly, the dye of the rewritable optical disks has a limited lifetime and access number. The reliability of any recorded data is degraded after repeated overwriting. When the overwriting number at an address or the average overwriting number over an address area exceeds a predetermined threshold, the verification determinator 315 will rate the address or the address area as unreliable. The verification determinator 315 will affirm/confirm the necessity of data verification for the address or the address area.

Moreover, certain areas of an optical disk, such as a file system area, require frequent modification or overwriting. The verification determinator 315 will affirm the necessity of data verification for those areas. The verification determinator 315 will affirm the necessity of data verification for important data area such as a main table area (MTA) of a Mt. Rainier disk.

Current commercially available rewritable optical disks may have different characteristics in different locations thereof. For example, the outer area of an optical disk has inferior characteristics in comparison with the inner area. The verification determinator 315 judges the necessity of data verification for the outer area of the optical disk with other auxiliary information such as writing speed, reading speed, and whether the disk is formatted or not.

An optical disk drive generally performs parameter measurement and calibration for adapting to various optical disks. More particularly, the RF level measurement, track pitch measurement, linear speed measurement, and optical power measurement are used to optimize the recording and reading quality. If the parameter measurement and calibration result are abnormal, the data quality is unreliable. Therefore, the verification determinator 315 determines the necessity of data verification based on parameter measurement and a calibration result.

Moreover, an actual defect address may be anticipated by the known defect record. The data quality of an address may be unreliable when the address per se or the neighborhood thereof is listed in the known defect record. The verification determinator 315 judges the necessity of data verification for the currently recording area by referencing the currently recording area to the known defect record. The verification determinator 315 judges the necessity of data verification for a specific data area by determining the defect amount or a defect distribution of the area with a threshold according to the known defect record.

Furthermore, an optical disk has dynamic (continuously changing and refreshing) disk states/information during its recording thereof. Data verification is influenced by the dynamic disk's states/information. For example, the currently recording area is moved with the progress of a recording operation. Therefore, the verification determinator 315 also needs an address-dependent judgment for the overwriting number of the optical disk, frequently overwritten areas, important data areas, outer areas of the optical disk, inferior areas identified by optical disk parameters, inferior areas identified by OPC results, and inferior areas identified by defect records. The reliability detector 313 will keep detecting the reliability of data and continuously updates its detection results. The verification determinator 315 also makes dynamic judgments according to the updated detection result of the reliability detector 313.

The verification determinator 315 may add/remove an area requiring data verification based upon the detection result of the reliability detector 313, preexistent states/information before data recording, and/or the dynamic disk states/information during recording. For example, the verification determinator 315 will perform data verification on a currently recording area when a defect address is near the currently recording area or the overwriting number of the currently recording area exceeds a threshold, even though the reliability detector 313 does not suggest performing data verification on the currently recording area. Moreover, if the currently recording area has a defect-prone address determined by the reliability detector 313 and the currently recording area is listed in the known defect record, the verification determinator 315 will not perform data verification on the currently recording area. This is because defect management is performed for the address in the known defect record, and the data integrity thereof is insured. Moreover, if a serious defect is found in the address range by the reliability detector 313 or is caused by a serious error of the writing means 303, the verification determinator 315 will label an address range as defective and not in need of data verification. In this situation, the verification determinator 315 will inform the defect manager 311 of the need to perform defect management over this address range.

The buffer size of the optical disk drive should also be taken into account. The verification determinator 315 will suspend a recording operation of a user's data to an address area when the user's data is larger than the buffer and the address area is judged to require data verification. Therefore, the user's data can be reserved for future data verification and defect management. Moreover, the verification determinator 315 will also suspend recording operations when data verification is required for an address area with data already recorded therein. The controller 307 receives a suspending command from the verification determinator 315 and then sends the suspending command to the writing means 303. The data verification and defect management are performed after the writing means 303 suspends the recording operation.

To sum up, the defect detecting method according to the present invention conducts data verification on a defect-prone address instead a global examination for address areas recorded with data. Therefore, the defect detecting efficiency is enhanced.

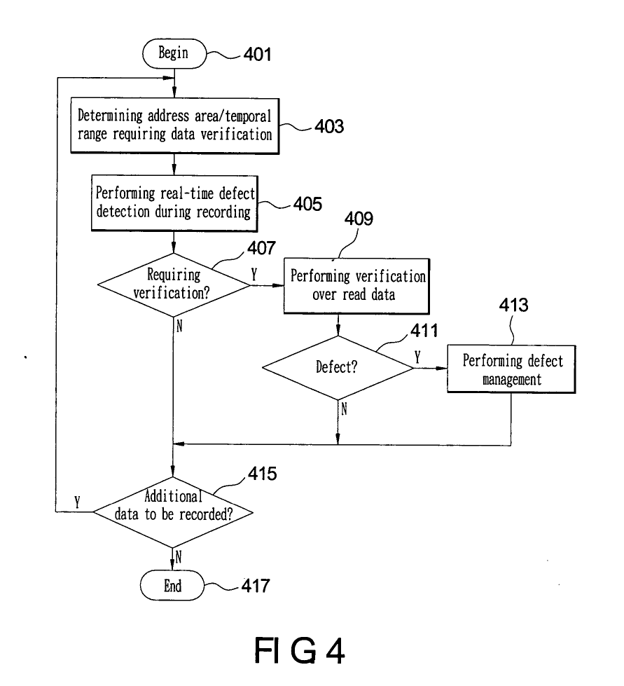

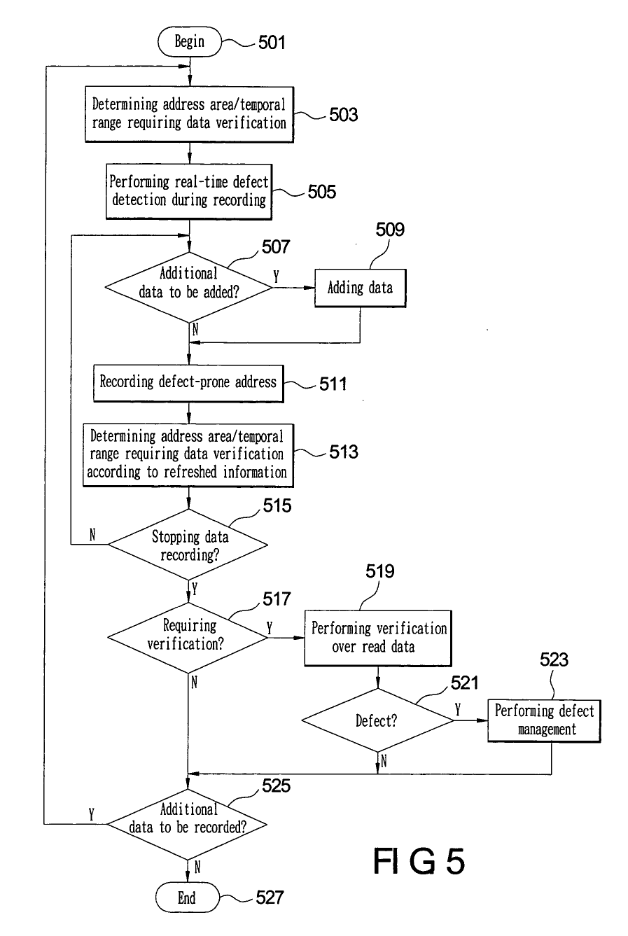

FIG. 4 shows a flowchart of a defect detecting method according to the first preferred embodiment of the present invention, which comprises of the following steps:

Step 401: Data recording is started by writing a designated user's data onto an optical disk by an optical disk drive.

Step 403: The optical disk drive determines an address area or a temporal range of the optical disk, which requires data verification, with reference to the preexistent states/information before data recording. The preexistent states/information includes the overwriting number of the optical disk, frequently overwritten areas, important data areas, outer areas of the optical disk, inferior areas identified by optical disk parameters, inferior areas identified by OPC results, and inferior areas identified by defect records. The determination criterion is described with reference to the verification determinator 315.

Step 405: The optical disk drive writes the user's data to a writing address of the optical disk and performs real-time defect detection on the writing address, whereby a defect-prone address is detected and recorded. The optical disk drive also generates dynamic disk states/information during data recording. The dynamic disk states/information includes a recording address, a recording area, an overwriting number, a defect distribution, and an accumulated defect signal. The operation of real-time defect detection to the writing address is described with reference to the description of the reliability detector 313. The generation of dynamic disk states/information is described with reference to the verification determinator 315.

Step 407: The optical disk drive determines the necessity of data verification and verification-demanding areas in view of the detection result of the reliability detector 313, preexistent states/information before data recording, and/or the dynamic disk states/information during recording. Moreover, the optical disk drive can also add/remove areas required for data verification. The decision for determining the necessity of data verification and verification-demanding areas is described with reference to the verification determinator 315.

Step 409: The optical disk drive reads the data in the data address for data verification if data verification is determined to be necessary. The data is verified by examining the data quality manifested by the error rate in the read data, the integrity of decoded data or the essential information integrity. It should be noted that the criterion for examining the data quality is not limited by the above description. Further details concerning step 409 can be found in the description of the defect detector 309.

Step 411: The optical disk drive determines the presence of an actual defect.

Step 413: The optical disk drive performs defect management if an actual defect is present and a defect address is identified after data verification. In the step of defect management, the data to be recorded in the defect address is reallocated to a spare area. Moreover, any defect information, such as the defect address and a mapping relationship between the defect address and the spare area, is also recorded, whereby the recorded data can be correctly reproduced.

Step 415: The optical disk drive confirms the successful recording of the user's data if the actual defect is not present or if the defect management for the actual defect is successful. The optical disk drive then checks if there is any further data that needs to be recorded. The procedure then returns to step 403 if there is further data that needs to be recorded; otherwise the procedure advances to step 417.

Step 417: Data recording is completed.

It should be noted that the data verification is determined based upon any real-time detection results for a defect-prone address, the preexistent states/information before data recording, and/or the dynamic disk states/information during recording. The defect detecting method according to the present invention conducts data verification on a defect-prone address instead of performing a global examination for address areas recorded with data. Therefore, the defect detecting efficiency is improved.

FIG. 5 shows a flowchart of a defect detecting method according to the second preferred embodiment of the present invention, which comprises of the following steps:

Step 501: Data recording begins by writing a designated user's data onto an optical disk via an optical disk drive.

Step 503: The optical disk drive determines an address area or a temporal range of the optical disk, which requires data verification, with reference to preexistent states/information before data recording. The preexistent states/information includes the overwriting number of the optical disk, frequently overwriting areas, important data areas, outer areas of the optical disk, inferior areas identified by the optical disk's parameters, inferior areas identified by OPC results, and inferior areas identified by defect records. The determination criterion can be found in the description of the verification determinator 315.

Step 505: The optical disk drive writes the user's data onto a writing address of the optical disk and then performs real-time defect detection on the writing address, whereby a defect-prone address is detected and recorded. The description of real-time defect detection can be found in the description of the verification determinator 315.

Step 507: The optical disk drive detects whether the user's data should be added to the buffer memory for writing onto the optical disk thereof.

Step 509: The user's data is added to the buffer of the memory of the optical disk drive.

Step 511: The defect-prone address is calculated and recorded.

Step 513: The optical disk drive determines an address area or a temporal range of the optical disk, which require data verification, with reference to the dynamic disk's states/information during data recording. The dynamic disk's states/information includes a recording address, a recording area, a overwriting number, a defect distribution, and an accumulated defect signal. A description of the determination criterion can be found in the description of the verification determinator 315.

Step 515: The optical disk drive determines whether the recording of the user's data should be stopped. If the result is determined to be yes, the procedure advances to step 517 for data verification; otherwise, the procedure returns to step 507.

Step 517: The optical disk drive determines the necessity of data verification and verification-demanding areas based upon the defect-prone address, the preexistent states/information before data recording and/or the dynamic disk states/information during recording. Moreover, the optical disk drive can also add/remove areas requiring data verification. A description of the determination regarding the necessity of data verification and the verification-demanding area can be found in the description of the verification determinator 315.

Step 519: The optical disk drive reads the data in the data address for data verification if the data verification is deemed to be necessary. The data is verified by examining the data quality manifested by the error rate in the read data, the integrity of decoded data or the essential information integrity. It should be noted that the criterion for examining the data quality is not limited by the above description. Details concerning step 519 can be referred found in the description of the defect detector 309.

Step 521: The optical disk drive determines the presence of an actual defect.

Step 523: The optical disk drive performs defect management if an actual defect is present and a defect address is identified after data verification. In defect management, the data to be recorded to the defect address is reallocated to a spare area. Moreover, the defect information, such as the defect address and a mapping relationship between the defect address and the spare area, is also recorded, whereby the recorded data can be correctly reproduced.

Step 525: The optical disk drive confirms the successful recording of the user's data if the actual defect is not present or if the defect management for the actual defect is completed. The optical disk drive then monitors the user's data to be recorded. The procedure returns to step 503 if there is data to be recorded; otherwise, otherwise the procedure advances to step 527.

Step 527: Data recording is completed.

The difference between the first embodiment and the second embodiment should be noted. In the second embodiment, the user's data is continuously added to the buffer memory of the optical disk drive, thus recording the user's data continuously. The first embodiment requires data verification after a predetermined amount of data is recorded. Therefore, the efficiency of the second embodiment is enhanced and is uninfluenced by the optical disk's buffer memory.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A defect detecting method for an optical disk, comprising the steps of:
recording data onto the optical disk;
determining whether it is necessary to perform a data verification procedure on the data on the optical disk according to defect information of the optical disk; and
performing the data verification procedure if necessary.

2. The defect detecting method as in claim 1, further comprising:
determining whether the step of recording the data onto the optical disk needs to be suspended according to the defect information.

3. The defect detecting method as in claim 1, further comprising:
generating the defect information according to a result of a reliability detecting process performed on the optical disk while recording the data.

4. The defect detecting method as in claim 1, wherein the defect information comprises an abnormal signal or abnormal information produced when an abnormality occurs during the step of recording the data onto the optical disk.

5. The defect detecting method as in claim 1, wherein the defect information comprises a location information of a known defect.

6. The defect detecting method as in claim 1, wherein the defect information comprises a defect management information of the optical disk.

7. The defect detecting method as in claim 1, wherein the defect information comprises an overwriting information that indicates how many times the optical disk has been overwritten.

8. The defect detecting method as in claim 1, wherein the defect information comprises an indication information showing whether the location of the data is in a specific region.

9. The defect detecting method as in claim 8, wherein the specific region is a frequently overwritten area.

10. The defect detecting method as in claim 8, wherein the specific region is a region with unreliable recording quality.

11. The defect detecting method as in claim 8, wherein the specific region is determined according to the number of defects or locations of known defects.

12. The defect detecting method as in claim 1, wherein, before recording the data, the defect information is produced according to an information of the optical disk or a location information of known defects.

13. The defect detecting method as in claim 1, wherein, during recording of the data, the defect information is produced according to a known information of the optical disk, a known location information of a defect, an updated information of the optical disk, or locations for recoding the data.

14. The defect detecting method as in claim 1, wherein the defect information is produced before or during recording of the data; if the defect information is produced before recording the data, the defect information is produced according to a information of the optical disk or a location information of known defects; if the defect information is produced during recording of the data, the defect information is produced according to a reliability detecting result of the optical disk, a known state and information of the optical disk, a known location information of defects, an updated information of the optical disk or locations for recoding the data.

15. The defect detecting method as in claim 1, further comprising:
determining a verification-demanding area for the data verification procedure according to the defect information.

16. The defect detecting method as in claim 15, wherein the step of determining the verification-demanding area further comprises:
removing a portion of the verification-demanding area or increasing the verification-demanding area according to the defect information.

17. The defect detecting method as in claim 15, wherein the step of determining the verification-demanding area further comprises:
determining whether an unknown defect exists according to a known location information of defects or defect information.

18. The defect detecting method as in claim 1, wherein the step of performing the data verification procedure further comprises:
reading data in the verification-demanding area for data verification.

19. The defect detecting method as in claim 1, wherein the data has an error correction mechanism.

20. The defect detecting method as in claim 19, wherein the step of performing the data verification procedure further comprises:
reading a recorded data and generating a data verification information according to an error information obtained through the error correction mechanism.

21. The defect detecting method as in claim 1, wherein the data has a data structure.

22. The defect detecting method as in claim 21, wherein the step of performing the data verification procedure further comprises:
reading a recorded data and generating a data verification information according to the accuracy of data in the data structure of the read recorded data.

23. The defect detecting method as in claim 1, further comprising a step of continuously adding the data during recording to achieve continuous recording.

24. The defect detecting method as in claim 1, further comprising a step of performing a defect management procedure.

25. The defect detecting method as in claim 24, wherein the step of performing a defect management procedure further comprises:
allocating the data associated with the defect address to a spare area of the optical disk and recording a defect record.

26. The defect detecting method as in claim 1, wherein the optical disk is a rewritable optical disk.

27. An apparatus for recording the data onto an optical disk, comprising
a verification determinator determining the necessity of performing a data verification procedure according to a defect information of the optical disk;
a controller performing the data verification procedure over a verification-demanding area determined by the verification determinator;
a reading means controlled by the controller for reading recorded data on the optical disk; and
a defect detector finding a defect address of the optical disk by reading data in the data verification procedure.

28. The apparatus as in claim 27, further comprising
a reliability detector for generating a defect detection result during recording of the optical disk.

29. The apparatus as in claim 28, wherein the defect detection result is obtained by detecting possible defects of the optical disk during recording the data.

30. The apparatus as in claim 28, wherein the defect detection result comprises an abnormal signal or abnormal information for indicating an abnormal condition during recording the data.

31. The apparatus as in claim 28, wherein the defect detection result is included in the defect information.

32. The apparatus as in claim 27, wherein the defect information comprises known location information of defects and known disk information.

33. The apparatus as in claim 27, wherein the defective information comprises known location information of defects.

34. The apparatus as in claim 27, wherein the defect information comprises known defect management information of the optical disk.

35. The apparatus as in claim 27, wherein the defect information comprises overwriting information that indicates how many times the optical disk has been overwritten.

36. The apparatus as in claim 27, wherein the defect information comprises indication information showing whether the location of the data is in a specific region.

37. The apparatus as in claim 36, wherein the specific region is a frequently overwritten area.

38. The apparatus as in claim 36, wherein the specific region is a region with unreliable recording quality.

39. The apparatus as in claim 36, wherein the specific region is determined according to locations of the number of known defects.

40. The apparatus as in claim 27, wherein the defect information comprises a defect detection result obtained by detecting possible defects of the optical disk during recording the data.

41. The apparatus as in claim 27, wherein, before recording the data, the defect information is produced according to known information of the optical disk or location information of known defects.

42. The apparatus as in claim 27, wherein, during recording the data, the defect information is produced according to a known information of the optical disk, location information of known defects, an updated information of the optical disk, or locations for recoding the data.

43. The apparatus as in claim 27, wherein the defect information is produced before or during recording of the data; if the defect information is produced before recording the data, the defect information is produced according to a information of the optical disk or location information of detects that are known; if the defect information is produced during recording the data, the defect information is produced according to a possible defects detecting result of the optical disk, a known information of the optical disk, known location information of defects, a updated information of the optical disk or locations for recoding the data.

44. The apparatus as in claim 27, wherein the verification determinator determines whether the recording process is necessary to be suspended according to the defect information.

45. The apparatus as in claim 27, wherein the verification determinator determines the verification-demanding area according to the defect information.

46. The apparatus as in claim 27, wherein the verification determinator adds and removes addresses from the verification-demanding area according to the defect information.

47. The apparatus as in claim 27, wherein the defect detector performs the data verification procedure according to data read in the verification-demanding area by the reading means.

48. The apparatus as in claim 27, wherein data recorded on the disk has an error correction mechanism.

49. The apparatus as in claim 48, wherein the defect detector generates data verification information according to error information generated by the error correction mechanism for recorded data.

50. The apparatus as in claim 27, wherein data recorded on the disk has a data structure.

51. The apparatus as in claim 50, wherein the defect detector reads recorded data and generates data verification information according to the accuracy of data in the data structure of read recorded data.

52. The apparatus as in claim 27, further comprising a defect manager for performing a defect management procedure.

53. The apparatus as in claim 52, wherein the defect manager allocates the data associated with a defect address to a spare area of the optical disk and records a defect record.

54. The apparatus as in claim 27, further comprising a writing means for recording the data onto the optical disk through a pickup head upon a command of the controller.

55. The apparatus as in claim 27, wherein the optical disk is a rewritable disk.
